(19) United States
(12) Patent Application Publication
(10) Pub. No.: US 2004/0230431 A1
(43) Pub. Date: Nov. 18, 2004

(54) Automatic assessment of phonological processes for speech therapy and language instruction

(76) Inventors: Sunil K. Gupta, Edison, NJ (US); Prabhu Raghavan, Edison, NJ (US); Chetan Vinchhi, Marlboro, NJ (US)

Correspondence Address: MENDELSOHN AND ASSOCIATES PC, 1515 MARKET STREET, SUITE 715, PHILADELPHIA, PA, 19102, US

(21) Appl. No.: 10/438,142

(22) Filed: May 14, 2003

(51) Int. Cl. G10L 15/04

(52) U.S. Cl. 704/254

(57) ABSTRACT

A computer-based system generates alternative pronunciations for a test word or phrase corresponding to specific phonological processes that replace individual phonemes or clusters of two or more phonemes with replacement phonemes. The system compares a user's pronunciation with a list of possible pronunciations that includes the base (i.e., correct) pronunciation of the test target as well as the different alternative pronunciations to identify the pronunciation that best matches the user's. The system identifies the phonological process(es), if any, associated with the user's pronunciation and generates statistics over multiple test targets that can be used to diagnose, in a speech therapy context, the user's specific phonological disorders.

### CROSS-REFERENCE TO RELATED APPLICATIONS

The subject matter of this application is related to U.S. patent application Ser. No. 10/188,539 filed Jul. 3, 2002, as attorney docket no. Gupta 8-14 (referred to herein as “the Gupta 8-14 application”), the teachings of which are incorporated herein by reference.

### BACKGROUND OF THE INVENTION

1. Field of the Invention

The present invention relates generally to signal analysis devices and, more specifically, to a method and apparatus for improving the language skills of a user.

2. Description of the Related Art

During the past few years, interest in using computer-based tools for speech and language therapy and for foreign language instruction has been increasing. Although currently available computer-based programs offer several useful features, such as therapy result analysis, report generation, and multimedia input/output, they all have a few key problems that limit their use to the classroom or therapist's office. These problems include:

No automatic assessment of phonological disorders.

No ability to easily and automatically customize the stimulus material for the specific needs of a student/patient.

High cost. Most speech therapy programs are relatively expensive so as to make them unaffordable for use at home. It is a well-known fact that most learning by children occurs when the parents are intimately involved in the child's therapy or language education.

### SUMMARY OF THE INVENTION

Problems in the prior art are addressed in accordance with the principles of the invention by a computer-based speech therapy tool that can analyze speech and automatically determine and provide statistics on the key phonological disorders that are discovered in a patient's speech. Such a program offers great benefit to the therapist and to the patient by allowing the therapy to continue outside the therapist's office. The present invention can also be applied in other contexts, such as foreign language instruction. The present invention addresses the growing interest in automated, computer-based tools for speech therapy and foreign language instruction that reduce the need for direct therapist/instructor supervision and provide quantitative measures to show the effectiveness of speech therapy or language instruction programs.

In one embodiment, the invention is a computer system comprising an alternative pronunciation (AP) generator, a speech recognition (SR) engine, and a score management (SM) module. The AP generator is adapted to generate one or more alternative pronunciations for a target. The SR engine is adapted to (1) compare a user's pronunciation of the target to a list of possible pronunciations comprising a base pronunciation for the target and the one or more alternative pronunciations and (2) identify a pronunciation in the list that best matches the user's pronunciation. The SM module is adapted to characterize the identified pronunciation to identify one or more phonological processes, if any, associated with the user's pronunciation.

In another embodiment, the invention is a computer-based method for generating one or more alternative pronunciations for a target. For one or more base phonemes/clusters in the target, one or more replacement phonemes/clusters are selected corresponding to one or more phonological processes, and the one or more alternative pronunciations are generated from different combinations of base phonemes/clusters and replacement phonemes/clusters.

### BRIEF DESCRIPTION OF THE DRAWINGS

Other aspects, features, and advantages of the invention will become more fully apparent from the following detailed description, the appended claims, and the accompanying drawings in which like reference numerals identify similar or identical elements.

FIG. 1 shows a block diagram depicting the components of a speech therapy system for automatic assessment of phonological disorders, according to one embodiment of the present invention;

FIG. 2 shows a flow diagram of the processing implemented by the alternative pronunciation generator of FIG. 1;

FIG. 3 shows a block diagram of the processing implemented by the score management module of FIG. 1 to determine the one or more phonological processes, if any, associated with a user's pronunciation of a given test target; and

FIG. 4 shows a high-level flow diagram of the overall processing implemented by the speech therapy system of FIG. 1.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

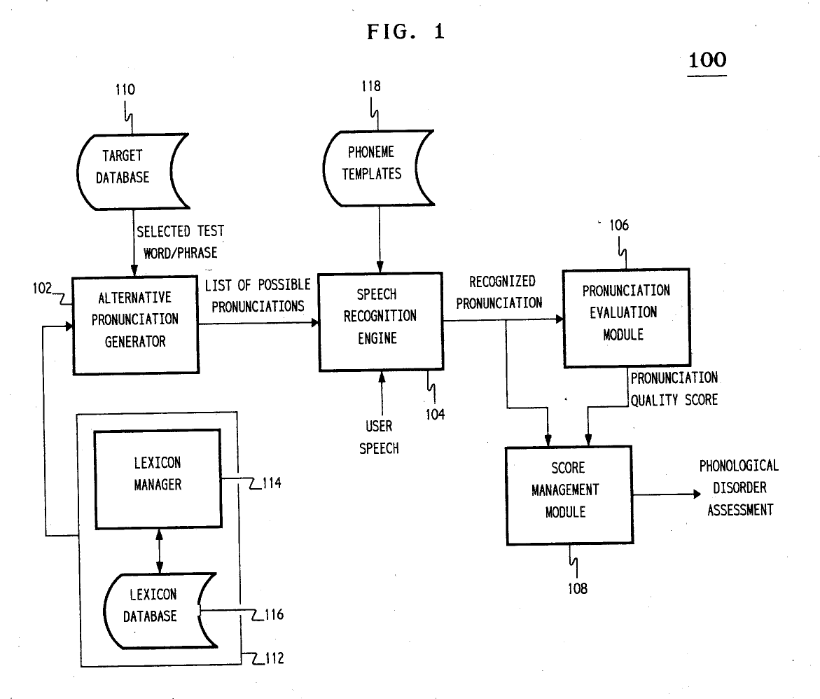

FIG. 1 shows a block diagram depicting the components of a speech therapy system 100 for automatic assessment of phonological disorders. Although preferably implemented in software on a conventional personal computer (PC), system 100 may be implemented using any suitable combination of hardware and software on an appropriate processing platform.

For each of a plurality of test word or phrases (i.e., targets), system 100 generates one or more alternative pronunciations that correspond to known phonological disorders to generate a list of possible pronunciations for the current test target, which list includes the base (i.e., correct) pronunciation and the one or more alternative (mis)pronunciations. When a user of system 100 (e.g., a speech therapy patient) pronounces one of the test targets into a microphone connected to system 100, the system compares the user's pronunciation to the corresponding list of possible pronunciations and selects the one that most closely matches the user's. System 100 compiles statistics on the user's pronunciations for a sufficient number and variety of different test targets to diagnose, if appropriate, the user's phonological disorder(s). Depending on the implementation, system 100 may then be able to use that diagnosis to appropriately control and tailor the flow of the speech therapy session for the individual user, e.g., focusing on test targets that are likely to be affected by the user's disorder(s).

Speech therapy system 100 has four main processing components: alternative pronunciation (AP) generator 102, speech recognition (SR) engine 104, pronunciation evaluation (PE) module 106, and score management (SM) module 108, each of which is responsible for a different phase of the system's functionality.

For a given test target, AP generator 102 automatically generates one or more alternative pronunciations that correspond to common phonological processes. For example, phonological processes for the two-phoneme cluster /dr/ in the word (drum) include /d/ as in (dum), /dw/ as in (dwum), and /d₃/ as in (jum). Moreover, phonological processes for the phoneme /d/ in (dum) include /g/ as in (gum). In that case, AP generator 102 might generate a list of possible pronunciations for the test word (drum) that includes the base pronunciation (drum) as well as the alternative pronunciations (dum), (dwum), (d₃um), and (gum), where the alternative pronunciation (gum) corresponds to a first phonological process replacing the /dr/ in (drum) with /d/, which is in turn replaced with /g/ as a result of another interacting/ordered phonological process.

In addition, the list of possible pronunciations for the test word (drum) generated by AP generator 102 might include additional alternative pronunciations resulting from phonological processes corresponding to the other phonemes in (drum), such as the phoneme /\hat{ }/ for the letter “u” in (drum) and the phoneme /m/ in (drum). According to a preferred implementation, if, for example, the phoneme /b/ as in (bees) were a phonological process for the phoneme /m/ in (drum), then, in addition to applying that phonological process to the target word (drum) to generate an alternative pronunciation corresponding to (drub), AP generator 102 would also apply that same phonological process to other possible pronunciations in the list (i.e., (dum), (dwum), (d₃ub), and (gum)) to generate additional alternative pronunciations corresponding to (dub), (d₃ub), (chub), and (gub), each of which corresponds to a combination of phonological processes affecting different parts of the same test word.

The inclusion of alternative pronunciations resulting from other interacting/ordered phonological processes as well as from combinations of two or more different phonological processes means that, for a typical test word or phrase, AP generator 102 might generate a relatively large number of different possible pronunciations corresponding to a wide variety of different phonological processes. The alternate pronunciation generator may also include an additional pronunciation validation module to remove any phonologically spurious pronunciations that are generated.

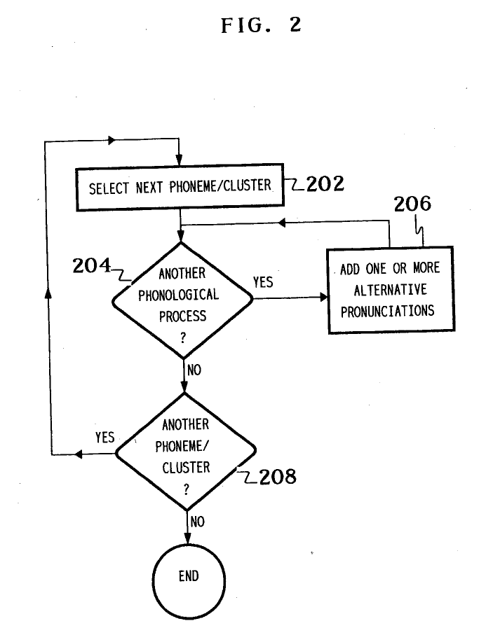

FIG. 2 shows a flow diagram of the processing implemented by alternative pronunciation generator 102, according to one embodiment of the present invention. In particular, AP generator 102 examines each different base phoneme and each different cluster of base phonemes in the base pronunciation for the current test target (steps 202 and 208), determines whether there are any phonological processes associated with that phoneme/cluster (step 204), and generates, from the existing list of possible pronunciations, one or more additional alternative pronunciations for the list by applying each different phonological process for the current phoneme/cluster to the appropriate possible pronunciations in the list (step 206).

Steps 202 and 208 sequentially select each individual phoneme in the test target, each two-phoneme cluster (if any), each three-phoneme cluster (if any), etc., until all possible phoneme clusters in the test target have been examined. For example, the word (striking) has seven phonemes corresponding to (s), (t), (r), (i), (k), (i), and (ng), two two-phoneme clusters corresponding to (st) and (tr), and one three-phoneme cluster corresponding to (str). As such, AP generator 102 would sequentially examine all ten phonemes/clusters in the test word (striking).

In one implementation, for step 204, AP generator 102 may rely on a look-up table that contains all phonemes and all phoneme clusters that can be modified/deleted as a result of a specific phonological process and the corresponding replacement phoneme/cluster. As described previously, any given phoneme/cluster may have one or more different possible phonological processes associated with it as well as one or more interacting processes. Moreover, some phonological processes may be applied across word boundaries in a test phrase.

For step 206, for the current phonological process for the current phoneme, AP generator 102 applies the phonological process to the existing list of possible pronunciations to generate one or more additional alternative pronunciations for the list by replacing the current phoneme with the corresponding replacement phoneme. Note that the replacement phone may be “NULL” indicating a phoneme deletion. In this way, the list of possible pronunciations generated by AP generator 102 can grow exponentially as the set of different phonemes and clusters in a word are sequentially examined.

In an alternative implementation, AP generator 102 generates a set of possible phonemes and clusters for each phoneme and cluster in the current test target, where, for a given phoneme/cluster in the target, the set comprises the base phoneme/cluster itself as well as any replacement phonemes/clusters corresponding to known phonological processes. After all of the different sets of possible phonemes/clusters have been generated for all of the different phonemes/clusters in the test target, AP generator 102 systematically generates the list of possible pronunciations by generating different combinations of phonemes/clusters, where each combination has one of the possible phonemes/clusters for each base phoneme/cluster in the target. The resulting list of possible pronunciations should be identical to the list generated by the method of FIG. B.

As indicated in FIG. 1, AP generator 102 receives information from target database 110 and lexicon sub-system 112, which includes lexicon manager 114 and lexicon database 116. Target database 110 stores the set of test words and phases to be spoken by a user for the assessment of phonological disorders. This database is preferably created by a speech therapist off-line (e.g., prior to the therapy session).

Lexicon manager 114 enables the therapist to add/remove words and phrases as test targets for a particular user and to manage the pronunciations for those test targets. For example, for individual test targets, lexicon manager 114 might allow the therapist to manually add other alternative pronunciations corresponding to abnormal phonological processes that are not automatically generated by alternative pronunciation generator 102. Lexicon database 116 is a dictionary containing base pronunciations for all of the test targets in target database 110.

AP generator 102 uses the information received from target database 110 and lexicon sub-system 112 to generate a list of possible pronunciations for the current test target for use by speech recognition engine 104.

In a preferred implementation, alternative pronunciation generator 102 operates in a text domain, while speech recognition engine 104 operates in an appropriate parametric domain. That is, each of the possible pronunciations generated by AP generator 102 is represented in the text domain by a corresponding set of phonemes identified by their phonetic characters, while SR engine 104 compares a parametric representation (e.g., based on Markov models) of the user's spoken input to analogous parametric representations of the different possible pronunciations and selects the pronunciation that best matches the user's input. Because of these two different domains (text and parametric), the list of possible pronunciations generated in the text domain by AP generator 102 must get converted into the parametric domain for use by SR engine 104.

In a preferred implementation, that text-to-parametric conversion occurs in SR engine 104 based on information retrieved from phoneme template database 118, which contains a mapping for each phoneme from the text domain into the parametric domain. The phoneme templates are typically built from a large speech database representing correct phoneme pronunciations. One possible form of speech templates is as Hidden Markov Models (HMMs), although other approaches such as neural networks and dynamic time-warping can also be used.

SR engine 104 identifies the pronunciation in the list of possible pronunciations received from AP generator 102 that best matches the user's input based on some appropriate measure in the parametric domain. In one embodiment, the Viterbi algorithm is used to determine the pronunciation that has the maximum likelihood of representing the input speech. See G. D. Forney, “The Viterbi Algorithm,” Proceedings of the IEEE, Vol. 761, No. 3, March 1973, pp. 268-278. SR engine 104 provides the selected pronunciation to both pronunciation evaluation module 106 and score management module 108.

Pronunciation evaluation module 106 evaluates the quality of phoneme pronunciation in the pronunciation selected by SR engine 104 as being the one most likely to have been spoken by the user. In a preferred implementation, the processing of PE module 106 is based on the subject matter described in the Gupta 8-1-4 application. The resulting pronunciation quality score generated by PE module 106 is provided to score management module 108 along with the selected pronunciation from SR engine 104.

Score management module 108 maintains score statistics and the current assessment of phonologic processes based upon all previous practice attempts by a user. The cumulative statistics and trend analysis based upon all the data enables overall assessment of phonological disorders. Depending on the implementation, this diagnosis of phonological disorders may be derived by a therapist reviewing the test results or possibly generated automatically by the system.

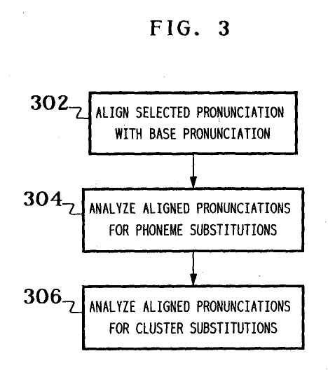

FIG. 3 shows a block diagram of the processing implemented by SM module 108 to determine the one or more phonological processes, if any, associated with a user's pronunciation of a given test target. In the text domain, SM module 108 aligns the pronunciation selected by SR engine 104 and the base (correct) target pronunciation using any suitable, well-known algorithm for aligning pronunciations (step 302 of FIG. 3). The resulting alignment of pronunciations indicates insertions, deletions, and/or substitutions of phonemes such that some appropriate phonological distance measure between the two pronunciations is minimized. An example of a phonological distance measure is the number of phonological features that are different between two pronunciations, where the distance measure is minimized at alignment.

For the aligned pronunciations, SM module 108 determines the corresponding phonological processes, if any. This may be accomplished by first looking for all possible substitutions of single phonemes in a look-up table that associates such substitutions with a corresponding phonological process (step 304). Once this is completed, clusters of two or more phonemes are searched for any process that affects such clusters (e.g., cluster reduction, syllable deletion) (step 306). Note that the processing of steps 304 and 306 is essentially the reverse of the process used by AP generator 102 to generate alternative pronunciations.

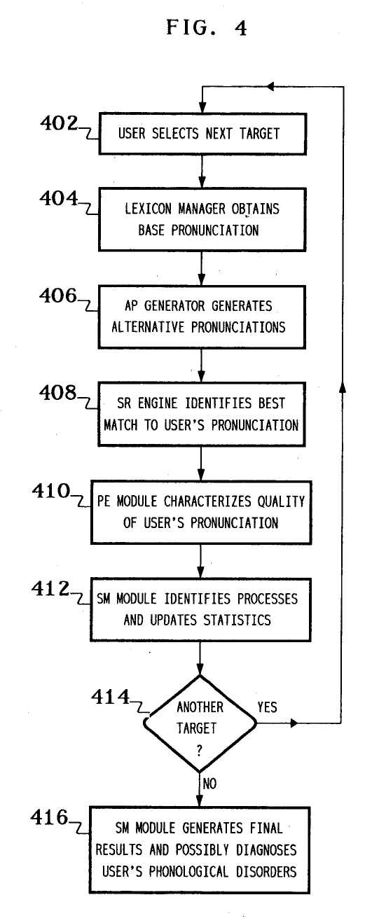

FIG. 4 shows a high-level flow diagram of the overall processing implemented by system 100. When a user (e.g., a speech therapy patient) selects a test word or phrase from target database 110 (step 402 of FIG. 4), lexicon manager 114 obtains the base pronunciation from lexicon database 116 (step 404). Alternative pronunciation generator 102 generates alternative pronunciations corresponding to different phonological disorders (step 406). Speech recognition engine 104 uses phoneme template database 118 to generate a parametric representation of each different possible pronunciation for the current target and compares those parametric representations to a parametric representation of the user's spoken pronunciation of the test target to identify the possible pronunciation that most closely matches the user's pronunciation (step 408). Pronunciation evaluation module 106 characterizes the quality of the user's spoken pronunciation (step 410). Score management module 108 identifies the phonological process(es) that produced the identified pronunciation from the base pronunciation and compiles corresponding statistics over all of the test targets (step 412). The processing of steps 402-412 is implemented for a number of different test targets (step 414). Although not shown in FIG. 4, the processing of steps 408-412 may also be performed for the same target based on different pronunciation attempts by the user. After all of the different targets have been tested (step 414), SM module 108 computes a list of phonological processes associated with the user and their frequencies of occurrence (step 416). Depending on the implementation, SM module 108 may also generate a diagnosis of the user's phonological disorder(s).

Depending on the implementation, system 100 may have additional components that present the target words/phrases to the user, play back speech data to the user, and present additional cues such as images or video clips.

As described above, system 100 has direct application in speech therapy. In particular, system 100 can support speech therapy that determines an optimal intervention program to remedy phonological disorders. System 100 enables a quick and accurate assessment of a patient's phonological disorders. System 100 provides automatic processing that requires virtually no intervention on the part of a therapist. As such, the patient can use this tool in the privacy and convenience of his or her own home or office, with the results being review later by a therapist.

System 100 also has application in other contexts, such as foreign language instruction. In particular, system 100 can provide an approach by which the foreign language instruction can continue beyond the school to the home, thereby significantly accelerating language learning. System 100 functions as a personal instructor when the student is away from school. The student can also use the system to identify specific areas where he or she needs most improvement in speaking a language.

The invention may be implemented as circuit-based processes, including possible implementation as a single integrated circuit, a multi-chip module, a single card, or a multi-card circuit pack. As would be apparent to one skilled in the art, various functions of circuit elements may also be implemented as processing steps in a software program. Such software may be employed in, for example, a digital signal processor, micro-controller, or general-purpose computer.

The invention can be embodied in the form of methods and apparatuses for practicing those methods. The invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

We claim:

1. A computer system comprising:
(a) an alternative pronunciation (AP) generator adapted to generate one or more alternative pronunciations for a target;
(b) a speech recognition (SR) engine adapted to (1) compare a user's pronunciation of the target to a list of possible pronunciations comprising a base pronunciation for the target and the one or more alternative pronunciations and (2) identify a pronunciation in the list that best matches the user's pronunciation; and
(c) a score management (SM) module adapted to characterize the identified pronunciation to identify one or more phonological processes, if any, associated with the user's pronunciation.

2. The invention of claim 1, wherein the SM module is further adapted to compile statistics on the phonological processes associated with a plurality of targets for use in diagnosing one or more phonological disorders of the user.

3. The invention of claim 2, wherein the SM module is further adapted to generate a diagnosis of a phonological disorder for the user.

4. The invention of claim 1, wherein, for one or more base phonemes/clusters in the target, the AP generator (1) selects one or more replacement phonemes/clusters corresponding to one or more phonological processes and (2) generates the one or more alternative pronunciations from different combinations of base phonemes/clusters and replacement phonemes/clusters.

5. The invention of claim 4, wherein at least one of the alternative pronunciations corresponds to an interacting/ordered phonological process associated with a single base phoneme/cluster in the target.

6. The invention of claim 4, wherein at least one of the alternative pronunciations corresponds to two or more phonological processes associated with two or more different base phonemes/clusters in the target.

7. The invention of claim 1, wherein the SR engine compares the user's pronunciation to the list of possible pronunciations in a parametric domain.

8. The invention of claim 7, wherein the AP generator generates the alternative pronunciations in a text domain.

9. The invention of claim 8, wherein the SR engine converts the list of possible pronunciations from the text domain to the parametric domain using a database of phoneme templates that contains a mapping of each different phoneme from the text domain to the parametric domain.

10. The invention of claim 1, wherein the SM module aligns the identified pronunciation with the base pronunciation to identify the one or more phonological processes associated with the user's pronunciation.

11. The invention of claim 1, further comprising a pronunciation evaluation module adapted to characterize quality of the user's pronunciation.

12. A computer-based method comprising:
(a) generating one or more alternative pronunciations for a target;
(b) comparing a user's pronunciation of the target to a list of possible pronunciations comprising a base pronunciation for the target and the one or more alternative pronunciations in order to identify a pronunciation in the list that best matches the user's pronunciation; and
(c) characterizing the identified pronunciation to identify one or more phonological processes, if any, associated with the user's pronunciation.

13. The invention of claim 12, further comprising compiling statistics on the phonological processes associated with a plurality of targets for use in diagnosing one or more phonological disorders of the user.

14. The invention of claim 13, further comprising generating a diagnosis of a phonological disorder for the user.

15. The invention of claim 12, wherein, for one or more base phonemes/clusters in the target, generating the one or more alternative pronunciations comprises (1) selecting one or more replacement phonemes/clusters corresponding to one or more phonological processes and (2) generating the one or more alternative pronunciations from different combinations of base phonemes/clusters and replacement phonemes/clusters.

16. The invention of claim 12, wherein the user's pronunciation is compared to the list of possible pronunciations in a parametric domain.

17. The invention of claim 16, wherein:
the alternative pronunciations are generated in a text domain; and
the list of possible pronunciations are converted from the text domain to the parametric domain using a database of phoneme templates that contains a mapping of each different phoneme from the text domain to the parametric domain.

18. A computer-based method for generating one or more alternative pronunciations for a target comprising, for one or more base phonemes/clusters in the target:
selecting one or more replacement phonemes/clusters corresponding to one or more phonological processes; and
generating the one or more alternative pronunciations from different combinations of base phonemes/clusters and replacement phonemes/clusters.

19. The invention of claim 18, wherein at least one of the alternative pronunciations corresponds to an interacting/ordered phonological process associated with a single base phoneme/cluster in the target.

20. The invention of claim 18, wherein at least one of the alternative pronunciations corresponds to two or more phonological processes associated with two or more different base phonemes/clusters in the target.
